(19) United States
(12) Patent Application Publication
(10) Pub. No.: US 2015/0221263 A1
(43) Pub. Date: Aug. 6, 2015

(54) THREE-DIMENSIONAL IMAGE DISPLAY DEVICE AND DRIVING METHOD THEREOF

(71) Applicant: Samsung Display Co., Ltd., Yongin-city (KR)

(72) Inventors: Jae Hyun KOH, Seoul (KR); Seung Gyun GO, Cheongju-si (KR); Young Rok NOH, Ansan-si (KR); Hyun-Sik YOON, Asan-si (KR); Jun Pyo LEE, Asan-si (KR)

(21) Appl. No.: 14/339,260

(22) Filed: Jul. 23, 2014

(30) Foreign Application Priority Data
Feb. 5, 2014 (KR) 10-2014-0013242

(51) Int. Cl. G09G 3/36; H04N 13/04

(52) U.S. Cl. CPC G09G 3/3607; H04N 13/0497; G09G 2310/027; G09G 2320/0209; G09G 2320/0233

(57) ABSTRACT

The present disclosure relates to a 3D image display device and a driving method thereof, and more particularly, to a 3D image display device including a shutter member and a driving method thereof. An exemplary embodiment of the present invention provides a 3D image display device including: a display panel including a plurality of pixels and a plurality of data lines; a data driver configured to apply a data voltage to the data lines; and a signal controller configured to receive an input image signal to generate an output image signal and control the data driver, wherein the signal controller includes a signal compensator for compensating the input image signal to have a clipped gray scale that is lower than a highest gray scale when the input image signal is the highest gray scale in a 3D mode.

### CROSS-REFERENCE TO RELATED APPLICATION

This application claims priority from and the benefit of Korean Patent Application No. 10-2014-0013242, filed on Feb. 5, 2014, which is incorporated herein by reference for all purposes as if fully set forth herein.

### BACKGROUND

1. Field

The present disclosure relates to a three-dimensional (3D) image display device and a driving method thereof, and more particularly, to a 3D image display device including a shutter member and a driving method thereof.

2. Discussion of the Background

As display device techniques have been developed, a display device capable of displaying a 3-dimensional (3D) image has attracted attention of consumers of electronic devices, and various 3D image displaying methods have been researched to provide users with evolved 3D display devices.

In general, in a 3D image display technology, stereoscopic perception of an object is represented by using binocular parallax as the largest factor for recognizing stereoscopic images at a near distance. More specifically, when different 2D images are reflected in a left eye and a right eye, respectively, and the image reflected in the left eye (hereinafter referred to as a “left eye image”) and the image reflected in the right eye (hereinafter referred to as a “right eye image”) are transferred to a brain, the left eye image and the right eye image in combination are processed in the brain to be recognized as the 3D image with depth perception or stereoscopic perception.

The 3D image display device uses the binocular parallax, and includes a stereoscopic method using glasses such as shutter glasses, polarized glasses, or the like, and an autostereoscopic method in which lenticular lens and a parallax barrier, or the like is disposed in a display device without using glasses.

In the 3D image display panel of the shutter glasses scheme, the left-eye image and the right-eye image are separated and continuously output from a display device, and the left-eye shutter and the right-eye shutter of the shutter glasses are selectively shut off by control of a shutter controller such that the 3D image is displayed.

In the shutter glasses scheme, as a driving method displaying the 3D image, there is a method of inserting an image frame of a predetermined gradation level or gray scale (e.g., a black gray) between a frame (referred to as “a left eye image display frame”) displaying a left eye image and a frame (referred to as “a right eye image display frame”) displaying a right eye image. In a method of inserting the image frame of the black gray between the left eye image display frame and the right eye image display frame, crosstalk in which the left eye image and the right eye image appear to be overlapped may be reduced. However the luminance of the 3D image may be largely decreased by an influence of the image frame of the black gray.

The above information disclosed in this Background section is only for enhancement of understanding of the background of the invention and therefore it may contain information that does not form the prior art that is already known in this country to a person of ordinary skill in the art.

### SUMMARY

With respect to a frame for displaying an image of a black gray to reduce a crosstalk phenomenon in a method of inserting the image frame of the black gray between the left eye image display frame and the right eye image display frame, it may be possible to use a method of maintaining a left eye image or a right eye image formed at a previous frame or re-displaying the same left or right eye image instead of an image of a black gray.

However, in the case of a driving method of maintaining a left eye image and a right eye image formed at a previous frame or a driving method of re-displaying the same left or right eye image instead of an image of a black gray, luminance of a 3D image is significantly reduced between the left eye image display frame and the right eye display frame, but the crosstalk phenomenon of a left eye image and a right eye image is increased.

To address such problems, exemplary embodiments of the present invention provide a 3D image display device and a driving method thereof, having advantages of reducing the crosstalk phenomenon of the left eye image and the right eye image while increasing the luminance of the 3D image.

Additional aspects will be set forth in part in the description which follows and, in part, will be apparent from the description, or may be learned by practice of the presented embodiments.

An exemplary embodiment of the present invention provides a three dimensional (3D) image display device, including: a display panel including a plurality of pixels and a plurality of data lines; a data driver configured to apply a data voltage to the data lines; and a signal controller configured to receive an input image signal to generate an output image signal and control the data driver. The signal controller includes a signal compensator to change the input image signal to have a clipped gray scale that is lower than a highest gray when the input image signal is a highest gray scale in a 3D mode.

An exemplary embodiment of the present invention provides a driving method of a three dimensional (3D) image display device, including a display panel including a plurality of pixels and a plurality of data lines, a data driver connected to the data lines, and a signal controller configured to control the data driver. The method includes receiving, by the signal controller, an input image signal, generating, by the signal controller, an output image signal by changing the input image signal to have a clipped gray scale that is lower than a highest gray scale when the input image signal is the highest gray scale in a 3D display mode, and inputting, by the signal controller, the output image signal to the data driver.

An exemplary embodiment of the present invention provides a three dimensional (3D) image display device including a signal controller configured to receive an input image signal to generate an output image signal, the output signal including a left eye image signal in a first frame and a right eye image signal in a second frame; a data driver configured to apply a data voltage to a data line; and a display panel including a plurality of pixels, the display panel being coupled to the data line. The first frame and the second frame are included in frames of a 3D mode, and the 3D image display device includes a signal compensator to change the input image signal to have a clipped gray scale that is lower than a highest gray scale in the 3D mode.

In accordance with exemplary embodiments of the present invention, it may be possible to reduce crosstalk phenomenon of the left eye image and the right eye image while increasing the luminance of the 3D image, thereby improve display quality.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a 3D image display device in accordance with an exemplary embodiment of the present invention.

FIG. 2 shows an example of a lookup table included in a signal controller included in the 3D image display device in accordance with an exemplary embodiment of the present invention.

FIG. 3 schematically shows an operation of the 3D image display device in accordance with an exemplary embodiment of the present invention.

FIG. 4 is a top plan view showing light emitting blocks of a backlight for supplying light to a display panel of the 3D image display device in accordance with an exemplary embodiment of the present invention.

FIG. 5 is a timing diagram showing an output sequence of output image signals inputted into a data driver of the 3D image display device in accordance with an exemplary embodiment of the present invention.

FIG. 6 is a timing diagram showing light transmittance of pixels, a data voltage according to the output image signals shown in FIG. 5, and luminance of an image displayed by the display panel in accordance with an exemplary embodiment of the present invention.

FIG. 7 is a timing diagram showing an output sequence of output image signals inputted into a data driver of the 3D image display device in accordance with an exemplary embodiment of the present invention.

FIG. 8 is a timing diagram showing light transmittance of pixels, a data voltage according to the output image signals shown in FIG. 7, and luminance of an image displayed by the display panel in accordance with an exemplary embodiment of the present invention.

FIG. 9 is a timing diagram showing an output sequence of output image signals inputted into a data driver of the 3D image display device in accordance with an exemplary embodiment of the present invention.

FIG. 10 is a timing diagram showing light transmittance of pixels, a data voltage according to the output image signals shown in FIG. 10, and luminance of an image displayed by the display panel in accordance with an exemplary embodiment of the present invention.

### DETAILED DESCRIPTION OF THE ILLUSTRATED EMBODIMENTS

Exemplary embodiment of the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In order to clarify the present invention, parts that are not connected with the description will be omitted, and the same elements or equivalents are referred to by the same reference numerals throughout the specification.

The terminology used herein is for the purpose of describing particular embodiments and is not intended to be limiting. Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

As used herein, the singular forms “a”, “an”, and “the” are intended to include the plural forms as well, unless the context clearly indicates otherwise. It will be further understood that the terms “comprises,” “includes,” “including,” and/or “comprising,” when used herein, specify the presence of stated features, components, groups, elements, steps, operations, and/or devices thereof, but do not preclude the presence or addition of one or more other features, components, groups, elements, steps, operations, and/or devices thereof. Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure. Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Hereinafter, a 3D image display device and a driving method thereof in accordance with exemplary embodiments of the present invention will be described with reference to accompanying drawings.

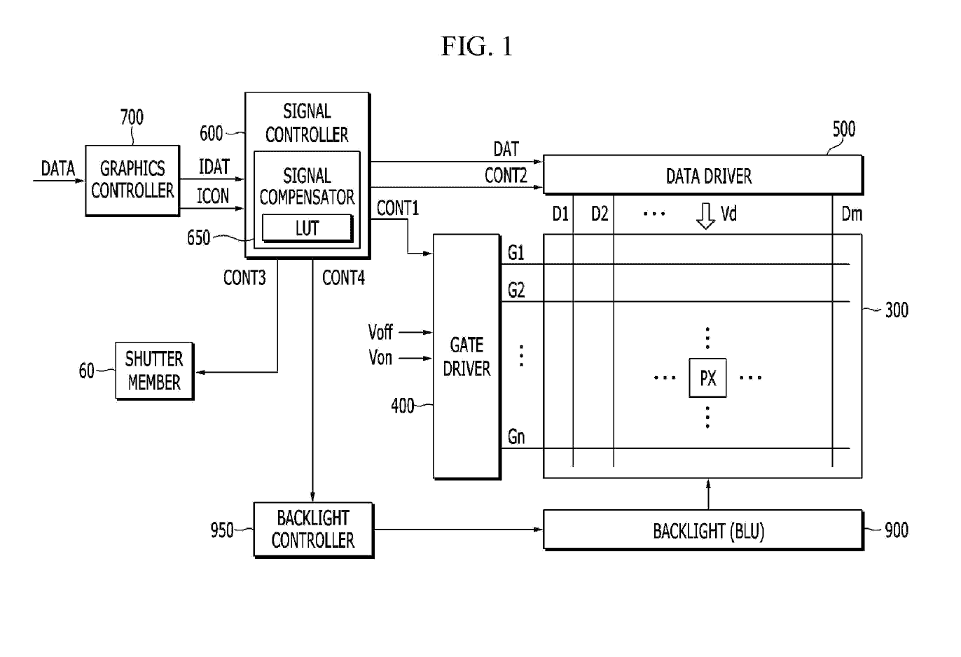

First, a 3D image display device and an operation thereof in accordance with an exemplary embodiment of the present invention will be described with reference to FIG. 1 to FIG. 4.

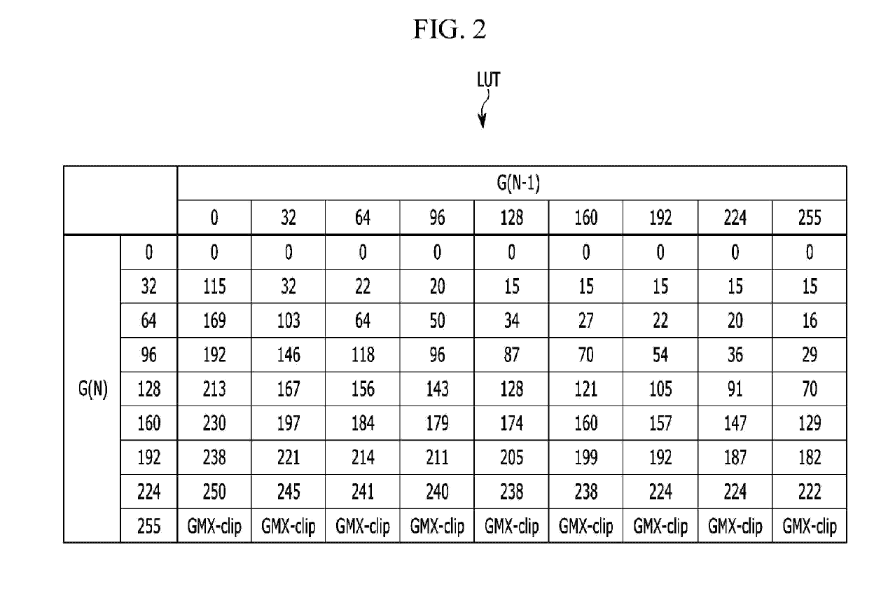

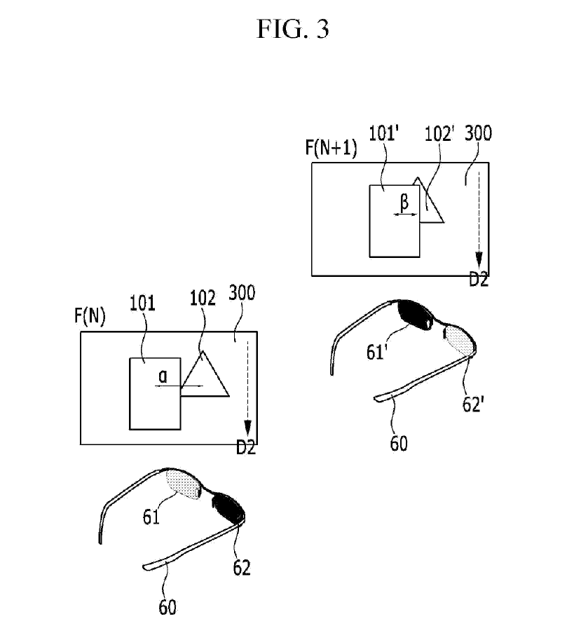

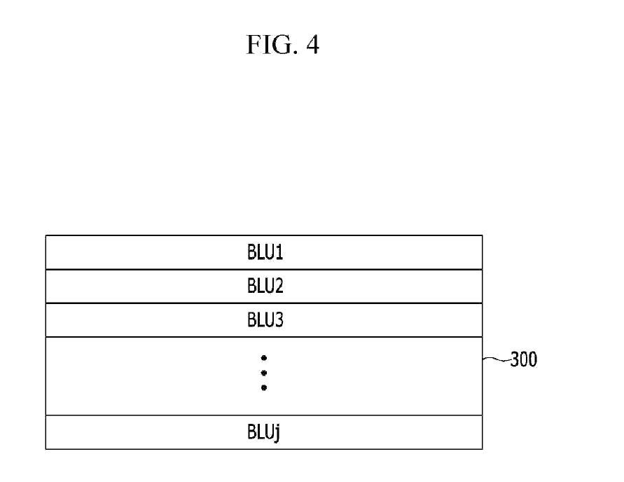

FIG. 1 is a block diagram of a 3D image display device in accordance with an exemplary embodiment of the present invention, FIG. 2 shows an example of a lookup table (LUT) included in a signal controller included in a 3D image display device in accordance with an exemplary embodiment of the present invention, FIG. 3 shows an operation of a 3D image display device in accordance with an exemplary embodiment of the present invention, and FIG. 4 is a top plan view showing light emitting blocks of a backlight for supplying light to a display panel of a 3D image display device in accordance with an exemplary embodiment of the present invention.

Referring to FIG. 1, the 3D image display device includes a graphics controller 700, a display panel 300, a gate driver 400 connected to the display panel 300, a data driver 500, a backlight (BLU) 900 for supplying light to the display panel 300, a backlight controller 950 for controlling the backlight 900, a signal controller 600, and a shutter member 60.

The graphics controller 700 receives image information data DATA shown in FIG. 1, a mode selection signal (not shown), and the like from the outside. The mode selection signal includes information related to a display mode, e.g., information on whether a display mode of the image is a 2D mode or a 3D mode, and a 3D driving scheme. The graphics controller 700 generates an input control signal ICON, shown in FIG. 1, for controlling display of an input image signal IDAT shown in FIG. 1, and the input image signal IDAT based on the image information data DATA and the mode selection signal.

The input image signal IDAT may include luminance information, and the luminance may have a predetermined number of gray shades. The input control signal ICON may include a vertical synchronization signal Vsync (not shown), a horizontal synchronizing signal Hsync (not shown), a main clock signal MCLK (not shown), a data enable signal DE (not shown), and the like regarding the image displaying. The input image signal IDAT and the input control signal ICON may be transmitted to the signal controller 600.

The display panel 300 may include a plurality of signal lines and a plurality of pixels PXs which are connected to the plurality of signal lines, when viewed as an equivalent circuit. If the display device is implemented as a liquid crystal display, the display panel 300 may include lower and upper display panels (not shown) which face each other, and a liquid crystal layer (not shown) interposed between the two display panels when viewed as a cross-sectional structure.

The signal lines include a plurality of gate lines G1-Gn which transfer gate signals and extend in a row direction, and a plurality of data lines D1-Dm which transfer data voltages and extend in a column direction. However, aspects are not limited as such. For example, the gate lines G1-Gn may extend in a column direction, and the data lines D1-Dm may extend in a row direction.

One pixel PX may include at least one switching element (not shown) which is connected to at least one of the data lines D1-Dm and at least one of the gate lines G1-Gn, and at least one pixel electrode (not shown) connected thereto. The switching element may include at least one thin film transistor, and may be controlled depending on a gate signal transferred by the gate lines G1-Gn to apply a data voltage Vd provided by the data lines to the pixel electrode.

In order to implement color display, each pixel PX displays one of primary or display colors (spatial division) or alternately displays the primary or display colors according to time (temporal division) so that a desired color may be recognized by the spatial or temporal sum of the primary or display colors.

The signal controller 600 receives the input image signal IDAT and the input control signal ICON from the graphics controller 700, and controls the operation of the gate driver 400, the data driver 500, the shutter member 60, and the backlight controller 950.

The signal controller 600 processes the input image signal IDAT according to an operation condition of the display panel 300 based on the received input image signal IDAT and the input control signal ICON to generate an output image signal DAT and generate a gate control signal CONT1, a data control signal CONT2, an image control signal CONT3, and a backlight control signal CONT4. The signal controller 600 transfers the gate control signal CONT1 to the gate driver 400, the data control signal CONT2 to the data driver 500, the 3D image control signal CONT3 to the shutter member 60, and the backlight control signal CONT4 to the backlight controller 950. The data control signal CONT2 includes a horizontal synchronization start signal which informs a transmission start of the output image signal DAT of a pixel PX of one row, at least one data load signal TP and a data clock signal which serve as an instruction to apply the data voltage to the data lines D1 to Dm, and the like.

The signal controller 600 is operated in a 2D mode displaying a 2D image or a 3D mode displaying a 3D image according to the mode selection signal. In the 3D mode, the output image signal DAT may include an image signal for different view points, for example, a left eye image signal and a right eye image signal.

The signal controller 600 may include a signal compensator 650, and the signal compensator 650 may perform signal compensation, e.g., dynamic capacitance compensation (DCC). The DCC will be described below in more detail.

The data driver 500 is connected to the data lines D1-Dm of the display panel 300. The data driver 500 may generate gray scale voltages for all gray scales by receiving a plurality of gray scale voltages from the outside or dividing a reference gray scale voltage inputted from the outside. The data driver 500 receives the output image signal DAT for the pixel of one row according to the data control signal CONT2 from the signal controller 600, and converts the output image signal DAT into a data voltage Vd by selecting a gray scale voltage corresponding to each output image signal DAT. The data driver 500 applies the data voltage Vd to a corresponding data line D1-Dm.

In the 3D mode, the data voltage Vd may include a right eye image data voltage (referred to as “a right eye data voltage”) corresponding to the right eye image signal and a left eye image data voltage (referred to as “a left eye data voltage”) corresponding to the left eye image signal.

The gate driver 400 is connected to the gate lines G1-Gn, and generates a gate signal formed of a combination of a gate-on voltage Von and a gate-off voltage Voff based on the gate control signal CONT1 inputted to the signal controller 600 to apply the gate signal to the gate lines G1-Gn.

If the gate driver 400 applies the gate-on voltage Von to the gate lines G1-Gn to turn on a switching element connected to the corresponding gate lines G1-Gn and to apply the data voltage Vd to the data lines D1-Dm, the data voltage Vd is applied to the pixel PX through the turned-on switching element. If the data voltage is applied to the pixel PX, the pixel PX can be charged with the pixel voltage to display the luminance corresponding to the data voltage Vd through various optical conversion elements. For example, in the case of the liquid crystal display, an inclined degree of liquid crystal molecules of the liquid crystal layer is controlled to control polarization of light, thereby displaying luminance corresponding to the gray scale of the input image signal IDAT.

When the data voltage is applied, the pixel voltage of the pixel PX is gradually changed until it is charged with a target pixel voltage corresponding to the data voltage Vd. This may require a specific time period. When the pixel PX reaches a stable state, the light transmittance may be made to be constant. As such, the pixel voltage when the pixel PX is in the stable state is referred to as “the target pixel voltage,” producing “target light transmittance”. Then, the target pixel voltage and the target light transmittance are in a one-to-one correspondence relationship. However, since a time during which the switching element of the pixel PX is turned on to apply the data voltage Vd is restrictive in certain circumstances, it may be difficult for the pixel PX to reach the stable state, and if the switching element is turned off, the pixel voltage may be varied. Accordingly, the target pixel voltage is applied to the pixel PX as it is, and the actual pixel voltage is different from the target pixel voltage, and thus it may not be possible to obtain the appropriate transmittance. As a result, the data voltage Vd to be applied to the pixel PX may be compensated or changed to be larger or smaller than the target pixel voltage by using various methods, such as the DCC.

Specifically, the DCC may be performed by the signal compensator 650 included in the signal controller 600. The signal compensator 650 may include at least one lookup table (LUT) for the DCC. The signal compensator 650 can compensate the current image signal by referring to the LUT based on the current image signal as an input image signal IDAT of the current frame for one pixel PX and a previous image signal as an input image signal IDAT of a previous frame for the pixel PX. The signal compensator 650 or the signal controller 600 may further include at least one frame memory (not shown) for storing a previous image signal.

Referring to FIG. 2, if the number of gray scales of the input image signal IDAT is, e.g., 256, the LUT may include a compensation signal for a pair of a previous image signal G(N−1) and the image signal G(N) of some gray scales. For the gray scales that are not included in the LUT, a compensation signal for the current image signal G(N) can be obtained by using interpolation or the like.

In the case that the display mode is a specific driving mode, e.g., a LHRH driving mode or an LLRR driving mode to be described later, among 3D modes, the LUT used when the DCC is performed may be provided separately from a LUT used in other driving methods or modes. The LUT may be selected according to a mode selection signal.

In accordance with the illustrated exemplary embodiment, when the 3D mode is a specific driving mode, e.g., a driving method in which an image for one input image signal IDAT is displayed during a plurality of frames, specifically the LHRH driving method or the LLRR driving method, a highest gray scale value of a compensation signal of the used LUT may be a clipped gray scale value GMX_clip that is lower than a highest gray (e.g., 255) of the current image signal G(N), and a difference therebetween may be equal to or greater than 1 gray scale. For example, if the number of all the gray scales is 256, the clipped gray scale value GMX_clip may be 255 or a gray scale that is smaller than 255.

Specifically, in accordance with an exemplary embodiment of the present invention, a compensation signal of the current image signal G(N) of the highest gray scale (e.g., 255) is the clipped gray GMX_clip which is a gray scale that is lower than the highest gray scale. Further, even when a compensation signal corresponds to a current image signal of a gray scale that is not the highest gray, the compensation signal is a clipped gray GMX_clip that is smaller than the highest gray (e.g. 255).

As such, if a 3D mode is determined as a certain mode in which a serious crosstalk phenomenon may occur, e.g., the LHRH driving mode or LLRR driving mode, a process for generating the highest gray scale of an output image signal DAT to be lower than the highest gray scale of the corresponding input image signal IDAT is referred to as “a clipping process.” This process may be performed by, e.g., changing the LUT when the DCC is performed by the signal compensator 650 as described above. However, this clipping process is not limited thereto, and may be performed by decreasing the highest gray scale to the clipping gray scale GMX_clip, or may be performed through an additional processing step after the DCC is performed. Otherwise, the clipping process may be performed in various signal processing step of the signal controller 600.

Referring back to FIG. 1, the shutter member 60 to realize the stereoscopic image display controls a left eye shutter and a right eye shutter such that an image for the left eye (referred to as “a left eye image”) is viewed by the left eye of a user through the left eye shutter and an image for the right eye (referred to as “a right eye image”) is viewed by the right eye of the user through the right eye shutter to the right eye, thereby generating a binocular disparity. That is, the shutter member 60 inputs images observed at different angles to different eyes, respectively, and thus an observer may perceive a 3D effect.

Referring to FIG. 3, the shutter member 60 may be, e.g., shutter glasses including a left eye shutter 61 or 61′ and a right eye shutter 62 or 62′. The above shutter glasses may include machine-type shutter glasses (goggles), optical shutter glasses, shutter glasses including a head mount and a shutter using a microelectromechanical system (MEMS), and the like.

Referring to FIG. 3, if the display panel 100 alternately displays left eye images 101 and 102 and right eye images 101′ and 102′, the right eye shutters 62 and 62′ and the left eye shutters 61 and 61′ of the shutter member 60 are synchronized with the display panel 300, thereby alternately blocking the light. The left eye shutters 61 and 61′ may be the left eye shutter 61 in an opened state or the left eye shutter 61′ in a closed state, and the right eye shutters 62 and 62′ may be the right eye shutter 62 in a closed state or the right eye shutter 62′ in an opened state. For example, during a time that the right eye shutter is in the opened state, the left eye shutter may be in the closed state. In contrast, during a time that the left eye shutter is in the opened state, the right eye shutter may be in the closed state. However, both the left eye shutter and the right eye shutter may be in the opened state or the closed state according to a display mode, e.g., a 2D mode.

When the left eye images 101 and 102 are displayed in the display panel 300, the left eye shutter 61 of the shutter member 60 is in the opened state such that the light corresponding to the left eye images 101 and 102 is transmitted and the right eye shutter 62 is in the closed state such that the light is blocked. When the right eye images 101′ and 102′ are displayed in the display panel 300, the right eye shutter 62′ of the shutter member 60 is in the opened state such that light corresponding to the right eye images 101′ and 102′ is transmitted and the left eye shutter 61′ is in the closed state such that the light is blocked. Accordingly, the left eye image may be recognized only by the left eye during a predetermined time, and then the right eye image may be recognized only by the right eye during a predetermined time. As a result, a 3-dimensional image having depth perception may be recognized by the difference between the left eye image and the right eye image.

The image recognized by the left eye as the image of the N^{th} frame F(N) is the image of which the left eye image 101 of a quadrangle and the left eye image 102 of a triangle are separated by a distance α. Further, the image recognized by the right eye as the image of the (N+1)^{th} frame F(N+1) is the image of which the right eye image 101′ of a quadrangle and the right eye image 102′ of a triangle are separated by a distance β. Herein, a and β may have different values. As described above, if the distance between the plurality of images recognized by two eyes is different, it may be recognized that the triangle is separated behind the quadrangle such that the depth perception may be perceived. It may be possible to adjust the distance (depth perception) between two objects spaced apart from each other by adjusting the distances a and 0 between the quadrangles and the triangles spaced apart from each other.

Referring back to FIG. 1, the shutter member 60 may be operated according to the stereoscopic image control signal CONT3 from the signal controller 600. The 3D image control signal CONT3 may include a synchronization signal controlling operation timing of the shutter member 60.

The backlight 900 may be positioned at the rear side of the display panel 300 and may include at least one light source. As an example of the light source, a fluorescent lamp such as a cold cathode fluorescent lamp (CCFL), a light emitting diode (LED) and the like may be included. The light source included in the backlight 900 may be turned on or off for a predetermined time according to the control of the backlight controller 950 depending on a backlight control signal CONT4. The backlight 900 may be simultaneously driven to correspond to an entire part of the display panel 300, or may be divided into a plurality of light emitting blocks BLU1, BLU2, . . . , and BLUj to be driven as shown in FIG. 4, j being a natural number that is equal to or greater than 2. The light emitting blocks BLU1, BLU2, . . . , and BLUj may emit light to correspond to different regions of the display panel 300, and may successively be turned on in one direction.

The backlight controller 950 drives the backlight 900 according to the backlight control signal CONT4 outputted from the signal controller 600.

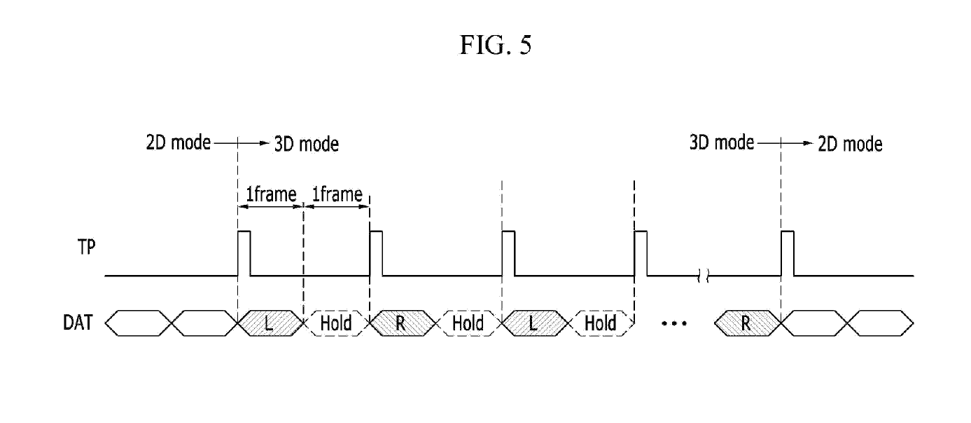

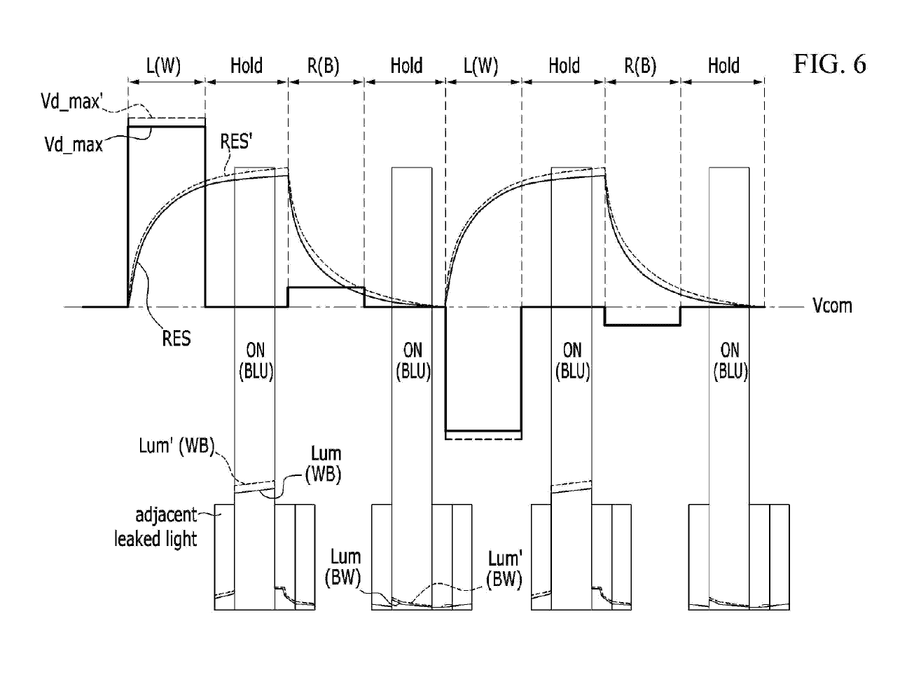

Hereinafter, a detailed driving method of the 3D image display device will be described with reference to FIG. 5 and FIG. 6 as well as FIG. 1 to FIG. 4.

FIG. 5 is a timing diagram showing an output sequence of output image signals inputted into a data driver of the 3D image display device in accordance with an exemplary embodiment of the present invention, and FIG. 6 is a timing diagram showing light transmittance of pixels, a data voltage according to the output image signals shown in FIG. 5, and luminance of an image displayed by the display panel in accordance with an exemplary embodiment of the present invention.

First, the signal controller 600 receives the input image signal IDAT and the input control signal ICON from the outside, and then processes the input image signal IDAT to generate the output image signal DAT. This operation may include the aforementioned operation of performing the DCC in the signal compensator 650.

In the case of the 3D mode, the output image signal DAT may include the image signal for the different viewing points, for example, the left eye image signal L and the right eye image signal R, and the signal controller 600 may alternatively output the left eye image signal L and the right eye image signal R.

The data driver 500 receives output image signals DAT for pixels PX in one row according to the data control signal CONT2 transmitted from the signal controller 600, and selects a gray scale voltage corresponding to each output image signal DAT to convert the output image signal DAT into a data voltage Vd which is an analog data signal and then apply the converted data voltage Vd to the corresponding data lines D1-Dm. The data driver 500 applies the data voltage Vd corresponding to the output image signal DAT to the data lines D1-Dm in synchronization with the data load signal TP.

The gate driver 400 applies the gate-on voltage Von to the gate lines G1-Gn according to the gate control signal CONT1 from the signal controller 600 to turn on the switching elements connected with the gate lines G1-Gn. Then, the data signal, which has been applied to the data lines D1-Dm, is applied to the corresponding pixels PX through the turned-on switching elements.

As such, if the gate-on voltages Von are applied to the gate lines G1-Gn, the switching elements connected to the gate lines G1-Gn are turned on, and the data voltages Vd applied to the data lines D1-Dm are applied to the corresponding pixels PX through the turned-on switching elements.

A difference between a data voltage applied to the pixel PX and a common voltage Vcom is represented as a pixel voltage. In the case of a liquid crystal display, the pixel voltage is a charging voltage of a liquid crystal capacitor, and an arrangement of liquid crystal molecules varies according to a magnitude of the pixel voltage, and as a result, polarization of light passing through a liquid crystal layer is changed. A change in the polarization is represented as a change in transmittance of light by a polarizer attached to the liquid crystal display.

The gate-on voltage Von is applied to all the gate lines G1-Gn so that the data voltage Vd is applied to all the pixels PX, and when the backlight 900 emits light to the display panel 300, the image of one frame can be displayed. The observer may divide and observe the left eye image and the right eye image by using the shutter member 60.

After one frame ends, the next frame starts. Then, a state of an inverse signal, which is applied to the data driver 500, is controlled to make the polarity of the data voltage Vd applied to each pixel PX opposite to the polarity of the previous frame. Even in one frame, polarities of the data voltages Vd flowing through one of the data lines D1-Dm may be periodically changed according to a characteristic of the inversion signal, or polarities of the data voltages Vd applied to the data lines D1-Dm in one pixel row may be different from each other.

Referring to FIG. 5, a holding period Hold may be positioned between an input period of a left eye image signal L of one frame and an input period of a right eye image signal R in a 3D mode. In the holding period Hold, a pixel voltage charged with the data voltage Vd corresponding to the left eye image signal L or the right image signal R of a previous frame is maintained for a predetermined time period. During the holding period Hold, no data voltage Vd is outputted from the data driver 500, and the pixel PX is not charged with a new data voltage Vd. The holding period Hold may be maintained during substantially one frame, but is not limited thereto.

In the holding period Hold, the rest of the response toward the target light transmittance of the pixel PX that has proceeded in a previous frame may proceed. When a discharging leakage current is smaller, the pixel voltage charged in the previous frame can be substantially constantly maintained during most of the holding period Hold.

The time obtained by adding the time period for inputting the data voltage for the left image signal L or the right image signal R of the previous frame and the time period for the holding period Hold immediately following the time period for inputting the data voltage for the left image signal L or the right image signal R of the previous frame may be the same as the time between the adjacent pulses of the data load signal TP. This time period may be about 16.7 ms, for example, i.e., the period of the data load signal TP may correspond to the time period of two frames. However, aspects are not limited as such. For example, the period of the data load signal TP may correspond to the time period of one frame according to other exemplary embodiments of the present invention.

The driving method of the 3D image display device described above is “the LHRH driving method” because this method includes a Hold period immediately after each left image signal L and after each right image signal R.

Hereinafter, the data voltage Vd, the light transmittance of the pixel PX, the change of the luminance of the pixel PX, and the like in the case of an example in which an input image signal IDAT for a left eye is the highest gray scale, i.e., a white gray scale W (referred to as “a left eye input image signal L(W)”), and an input image signal IDAT for a right eye is the lowest gray scale, a black gray scale B (referred to as “a right eye image signal R(B)”) will be described with reference to FIG. 5 and FIG. 6.

Referring to FIG. 6, if the left eye input image signal L(W) is processed without the clipping process, it will be converted into a highest data voltage Vd_max′ to be outputted. However, in accordance with the illustrated exemplary embodiment, the left eye input image signal L(W) is clipped in the signal controller 600 and converted into a clipped highest data voltage Vd_max corresponding to the clipped gray scale GMX_clip to be outputted to the display panel 300. The clipped highest data voltage Vd_max is lower than the highest data voltage Vd_max′.

In the holding period, no data voltage Vd is outputted.

The light transmittance RES of the pixel PX that receives the data voltage Vd gradually increases according to the clipped highest data voltage Vd_max. The light transmittance RES depends on a reaction speed of an optical converting element, e.g., a liquid crystal layer of the pixel PX. As shown in FIG. 6, the light transmittance RES of the pixel PX that receives the clipped highest data voltage Vd_max may be lower than that the light transmittance RES' of the pixel PX that receives the highest data voltage Vd_max′, and may be slowly increased. However, the light transmittance RES of the pixel PX that receives the clipped highest data voltage Vd_max may be higher than the light transmittance of the 3D driving method for inserting a black gray between a left image display frame and a right eye image display frame (this driving method is referred to as the LBRB driving method).

During the holding period Hold, no data voltage Vd may be outputted. The light transmittance RES of the pixel PX that receives the clipped highest data voltage Vd_max at the frame before the holding period Hold may be further increased or substantially constantly maintained.

Next, after the holding period Hold is completed, the right eye input image signal R(B) is converted into the data voltage Vd to be outputted. As a result, the light transmittance RES of the pixel PX that receives the data voltage Vd gradually decreases. Since the light transmittance RES at the last viewing point of a previous holding period Hold is lower than the light transmittance RES' in the case that the clipping process is not performed, the light transmittance RES at the frame at which the data voltage Vd for the right eye input image signal R(B) may also be lower than the light transmittance RES' in the case that the clipping process is not performed as shown in FIG. 6, and may also be downwardly moved.

Particularly, as in the liquid crystal display, a falling response speed of the liquid crystal molecules when a high luminance is changed to a low luminance tends to be lower than a rising response speed in the opposite case. According to the illustrated exemplary embodiment, it may be possible to make the falling response speed relatively quicker through the clipping process as compared with the case in which no clipping process is performed.

The light emitting blocks of the backlight 900 of the pixel PX that receives the data voltage Vd, or the backlight 900, may be turned on to emit light to the corresponding pixel during at least a part of the holding period Hold after the data voltage Vd is inputted as shown in FIG. 6. The on-timing and time of the backlight 900 may be variously changed without being limited to the example shown in FIG. 6.

Referring to FIG. 6, the luminance Lum(WB) of an image displayed by the pixel PX at the holding period Hold next to the frame to which the clipped highest data voltage Vd_max for the left eye input image signal L(W) is applied may be lower than the luminance Lum′(WB) in the case that no clipping process is performed.

Here, the luminance Lum(WB) or the luminance Lum′(WB) indicates the luminance of an image displayed by the left eye input image signal L(W) when the left eye input image signal L(W) is a white gray scale W, and the right eye input image signal R(B) is a black gray scale B. Similarly, the luminance Lum(BW) or the luminance Lum′(BW) indicates the luminance of an image displayed by the right eye input image signal R(B) when the left eye input image signal L(W) is the white gray scale W, and the right eye input image signal R(B) is the black gray scale B.

As shown in FIG. 6, the backlight 900 includes a plurality of light emitting blocks, and when it is driven in a scanning method, the light emitted from the light emitting blocks of the backlight 900 that is turned on may pass through a region adjacent to the corresponding pixel PX that is turned on, thereby making an image of a luminance visible.

Next, when the light emitting blocks of the backlight 900 corresponding to the pixel PX, or the backlight 900, are turned on during at least a part of the holding period Hold next to the frame to which the data voltage Vd_max for the right eye input image signal R(B) is applied, the luminance Lum(BW) of an image displayed by the pixel PX may be lower than the luminance Lum′(BW) in the case in which no clipping process is performed.

Accordingly, an effect of a left eye image for a right eye image indicating a black gray scale can be almost removed, thereby displaying a luminance close to a target black gray scale. Particularly, when an image in which the pixel PX is changed from the white gray scale to the black gray scale is displayed, crosstalk of left and right images may be reduced. Specifically, in the illustrated exemplary embodiment, the crosstalk of a 3D image is calculated by Equation 1.

Crosstalk={Lum(BW)−Lum(BB)}/{Lum(WB)−Lum(BB)} [Equation 1]

In Equation 1, the luminance Lum(BW) and the luminance Lum(WB) are the same as described above, and Lum(BB) indicates the luminance of an image displayed by the left eye input image signal when the left eye input image signal is the black gray scale B and the right input image signal is the black gray scale B.

In accordance with Equation 1, the crosstalk can be reduced by adjusting the luminance Lum(WB) and the luminance Lum(BW). Further, in the illustrated exemplary embodiment, the crosstalk can be reduced by simultaneously adjusting the luminance Lum(WB) and the luminance Lum(BW).

Specifically, as the difference between the highest gray scale of the input image signal IDAT and the clipped gray scale GMX_clip becomes larger, the luminance Lum(WB) may be reduced, but the luminance Lum(BW) may be reduced relatively more, thereby decreasing the crosstalk. Further, as the difference between the highest gray scale of the input image signal IDAT and the clipped gray GMX_clip becomes smaller, the luminance Lum(WB) may not be reduced significantly, but a degree by which the luminance Lum(BW) becomes lower may be reduced more significantly, thereby decreasing the effect of reducing the crosstalk. As a result, the luminance Lum(WB) and the luminance Lum(BW) are affected by each other. Accordingly, it may be possible to appropriately adjust the clipped gray GMX_clip in consideration of a trade-off relationship between the luminance Lum(WB) and the luminance Lum(BW).

In the case of the LHRH driving method of the illustrated exemplary embodiment, the luminance of a 3D image is higher as compared with the LBRB driving method for inserting the black gray scale between the left eye image display frame and the right eye image display frame. Thus, according to the illustrated exemplary embodiment, it may be possible to increase display quality of the 3D image by reducing the crosstalk between the left image and the right image while increasing the luminance of the 3D image.

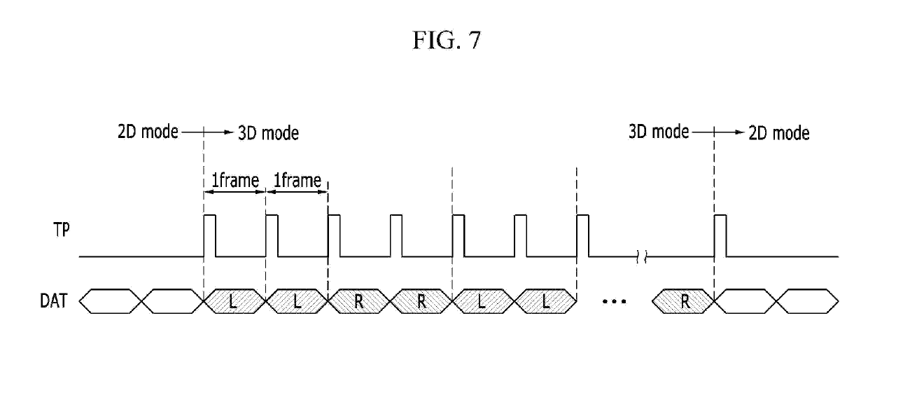

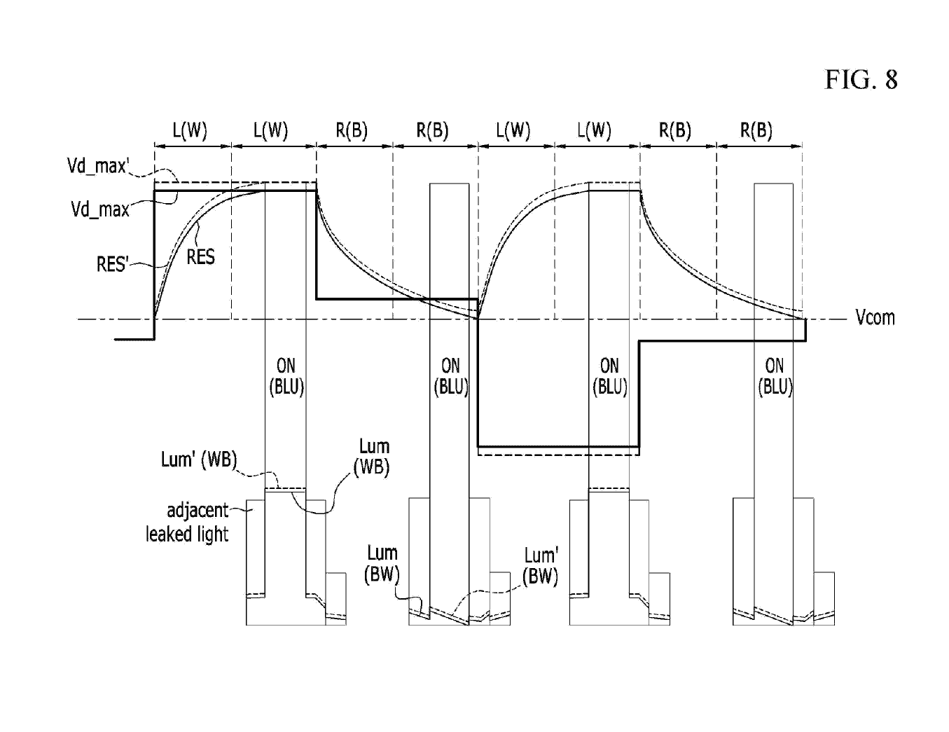

Next, a driving method of a 3D image display device in accordance with another exemplary embodiment of the present invention will be described with reference to FIG. 7 and FIG. 8 as well as FIG. 1 to FIG. 4.

FIG. 7 is a timing diagram showing an output sequence of output image signals inputted into a data driver of the 3D image display device in accordance with an exemplary embodiment of the present invention, and FIG. 8 is a timing diagram showing light transmittance of pixels, a data voltage according to the output image signals shown in FIG. 7, and luminance of an image displayed by the display panel in accordance with an exemplary embodiment of the present invention.

The driving method of the 3D image display device illustrated in FIG. 7 and FIG. 8 is similar to the driving method described with reference to FIG. 5 and FIG. 6, and thus the description for the same features and operations will be omitted and features and operations will be described based on the differences therebetween.

Referring to FIG. 7, in the 3D mode, the left eye image signal L or the right eye image signal R for one input image signal IDAT may be inputted multiple times in continuous frames. For example, as shown in FIG. 7, the left eye image signal L for one left eye input image signal L(W) may be inputted two times according to a pulse of the data load signal TP in two continuous frames, and the right eye image signal R for one right eye input image signal R(B) may be inputted two times according to a pulse of the data load signal TP in two continuous frames. The time between adjacent pulses of the data load signal TP may be substantially the same as one frame (i.e., the period of the data load signal TP may correspond to the time period of one frame), and one frame may be, e.g., substantially 8.33 ms, but is not limited thereto. For example, a driving frequency at which the frame is repeated may be substantially 240 Hz or other frequencies.

This driving method of the 3D image display device is “the LLRR driving method” described above.

Hereinafter, the data voltage Vd, the light transmittance of the pixel PX, the change of the luminance of the pixel PX, and the like for the left eye input image signal L(W) and the right eye input image signal R(B) will be described with reference to FIG. 8 as well as FIG. 7.

Referring to FIG. 8, the data voltage Vd for one left input image signal L(W) is inputted into the pixel PX for a specific number of times in the same number of continuous frames, e.g., two continuous frames.

If the left eye input image signal L(W) is processed without the clipping process, the data voltage thereof will reach the highest data voltage Vd_max′ to be outputted. However, in accordance with the illustrated exemplary embodiment, the left eye input image signal L(W) is clipped in the signal controller 600 and converted into the clipped highest data voltage Vd_max corresponding to the clipped gray scale GMX_clip to be outputted to the display panel 300. The clipped highest data voltage Vd_max is lower than the highest data voltage Vd_max′.

The light transmittance RES of the pixel PX that receives the data voltage Vd for the left eye input image signal L(W) gradually increases. The light transmittance RES depends on a reaction speed of an optical converting element, e.g., a liquid crystal layer of the pixel PX. As shown in FIG. 8, the light transmittance RES of the pixel PX that receives the clipped highest data voltage Vd_max may be lower than that the light transmittance RES' of the pixel PX that receives the highest data voltage Vd_max′, and may be slowly increased. However, the light transmittance RES of the pixel PX that receives the clipped highest data voltage Vd_max may be higher than the light transmittance of the 3D driving method for inserting a black gray scale between a left eye image display frame and a right eye image display frame (this driving method that inserts the black gray scale between the left eye image display frame and the right eye image display frame is referred to as the LBRB driving method). Further, the light transmittance RES of the pixel PX has a shorter time of reaching the target light transmittance as compared with the light transmittance RES of the aforementioned LHRH driving method, and thus rising response speed may become significantly faster than the LHRH driving method, thereby further improving the luminance of the 3D image.

In a second frame for one input image signal L(W), the light transmittance RES can almost maintain the target light transmittance.

Next, after the input of the data voltage Vd during the plurality of frames for the left eye input image signal L(W), the right eye input image signal R(B) is converted into data voltage Vd for the right eye input image signal R(B) to be inputted into the pixel PX for a specific number of times in the same number of continuous frames, e.g., two continuous frames.

The light transmittance RES of the pixel PX that receives the data voltage Vd for the right eye input image signal R(B) gradually decreases. In accordance with the illustrated exemplary embodiment, since the light transmittance RES at the last viewing point of a previous holding period Hold is lower than the light transmittance RES' in the case that the clipping process is not performed, the light transmittance RES at a first frame in which the data voltage Vd for the right eye input image signal R(B) is inputted may also be lower than the light transmittance RES' in the case that the clipping process is not performed as shown in FIG. 8, and may also be downwardly moved. Further, the light transmittance RES can be more quickly reduced in the second frame that receives the data voltage Vd for the same right input signal R(B).

According to the illustrated exemplary embodiment, it may be possible to make the falling response speed relatively quick through the clipping process as compared with the case that no clipping process is performed.

The light emitting blocks of the back light 900 corresponding to the pixel PX that receives the data voltage Vd, or the backlight 900, may be turned on to emit light to the corresponding pixel during at least a part of a second frame of the two frames in which the data voltage Vd for the left eye input image signal L(W) and the data voltage Vd for the right eye input image signal R(B) is inputted as shown in FIG. 8. The on-timing and time of the backlight 900 may be variously changed without being limited to those shown therein.

Referring to FIG. 8, the luminance Lum(WB) of an image displayed by the pixel PX may be lower than the luminance Lum′(WB) in the case that no clipping process is performed in the case that the clipped highest data voltage Vd_max for the left eye input image signal L(W) is applied.

Next, when the light emitting blocks of the back light 900 corresponding to the pixel PX, or the backlight 900, are turned on during at least a part of the second frame of the two frames in which the data voltage Vd for the two consecutive right eye input image signal R(B) is inputted, the luminance Lum(BW) of an image displayed by the pixel PX may be lower than the luminance Lum′(BW) in the case that no clipping process is performed.

Accordingly, an effect of a left eye image for a right eye image indicating a black gray scale can be more effectively removed, thereby displaying a luminance close to a target black gray scale. Particularly, when an image in which the pixel PX is changed from the white gray scale to the black gray scale is displayed, crosstalk between the left image and the right image may be reduced. Further, in the case of the LLRR driving method, the luminance of a 3D image is higher as compared with the LBRB driving method or the LHRH driving method. Thus, according to the illustrated exemplary embodiment, it may be possible to increase display quality of the 3D image by reducing the crosstalk between the left image and the right image while increasing the luminance of the 3D image.

Other features and effects of the exemplary embodiment described with reference to FIG. 5 and FIG. 6 may be applied to the exemplary embodiment described with reference to FIG. 7 and FIG. 8.

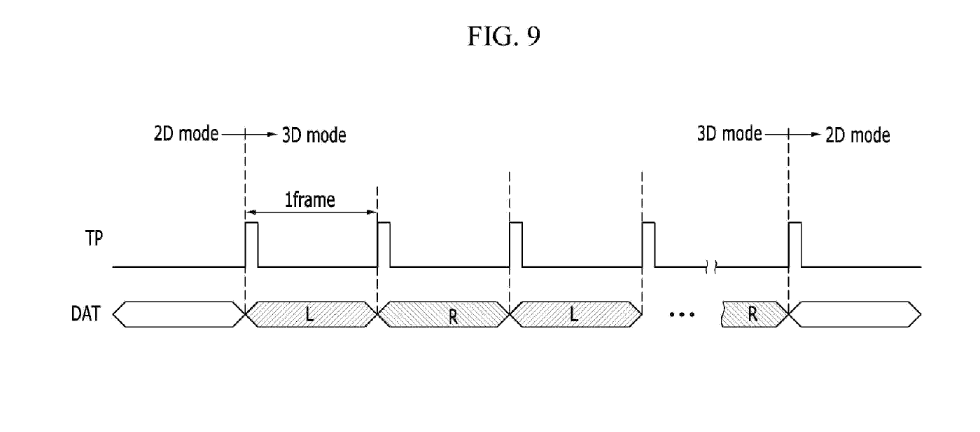

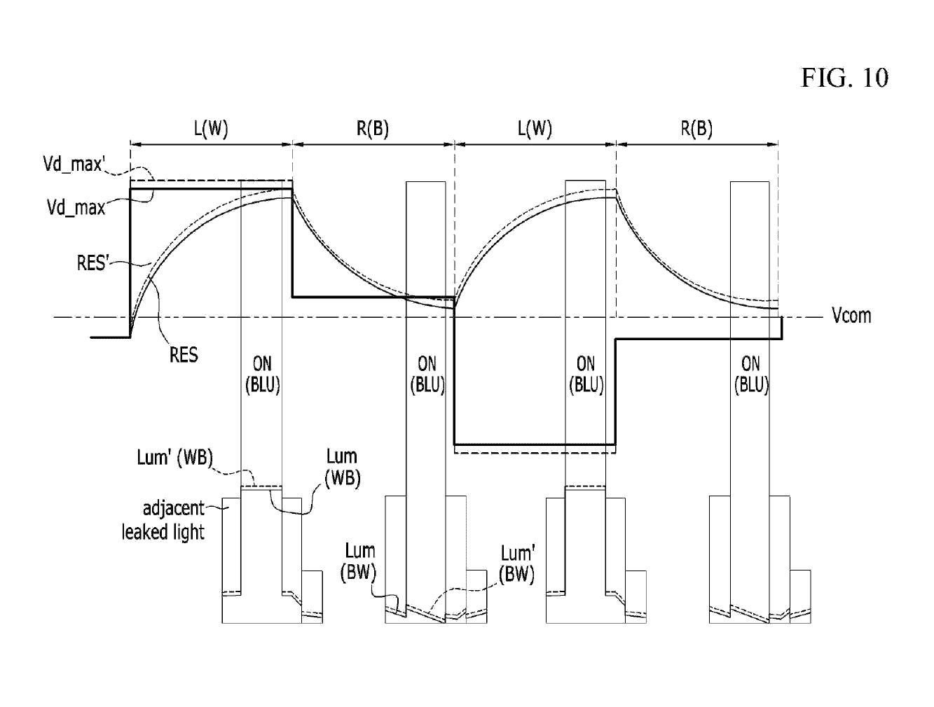

Next, a driving method of a 3D image display device in accordance with another exemplary embodiment of the present invention will be described with reference to FIG. 9 and FIG. 10 as well as FIG. 1 to FIG. 4.

FIG. 9 is a timing diagram showing an output sequence of output image signals inputted into a data driver of the 3D image display device in accordance with an exemplary embodiment of the present invention, and FIG. 10 is a timing diagram showing light transmittance of pixels, a data voltage according to the output image signals shown in FIG. 10, and luminance of an image displayed by the display panel in accordance with an exemplary embodiment of the present invention.

The driving method of the 3D image display device in accordance with the exemplary embodiment described with reference to FIG. 9 and FIG. 10 is similar to the driving method described with reference to FIG. 5 and FIG. 6, and thus the similar description will be omitted and different features and operations will be described based on the differences therebetween.

Referring to FIG. 9, in the 3D mode, the left eye image signal L or the right eye image signal R for one input image signal IDAT may be inputted at one time during one frame. Further, the left eye image signal L and the right eye image signal R may be alternatively inputted. In this case, the time between adjacent pulses of the data load signal TP is substantially the same as one frame, and one frame may be, e.g., substantially 16.7 ms, but is not limited thereto. For example, a driving frequency at which the frame is repeated may be about 240 Hz.

This driving method of the 3D image display device is “the LR driving method.”

Hereinafter, the data voltage Vd, the light transmittance of the pixel PX, the change of the luminance of the pixel PX, and the like for the left eye input image signal L(W) and the right eye input image signal R(B) will be described with reference to FIG. 10 as well as FIG. 9.

Referring to FIG. 10, the data voltage Vd for one left eye input image signal L(W) is applied to the pixel PX during one frame.

If the left eye input image signal L(W) is processed without the clipping process, it will be converted into the highest data voltage Vd_max′ to be outputted. However, in accordance with the illustrated exemplary embodiment, the left eye input image signal L(W) is clipped in the signal controller 600 and converted into the clipped highest data voltage Vd_max corresponding to the clipped gray scale GMX_clip to be outputted to the display panel 300. The clipped highest data voltage Vd_max is lower than the highest data voltage Vd_max′.

The light transmittance RES of the pixel PX that receives the data voltage Vd for the left eye input image signal L(W) gradually increases. As shown in FIG. 10, the light transmittance RES of the pixel PX that receives the clipped highest data voltage Vd_max may be lower than that of the light transmittance RES' of the pixel PX that receives the highest data voltage Vd_max′, and may be slowly increased. However, the light transmittance RES of the pixel PX that receives the clipped highest data voltage Vd_max may be higher than the light transmittance of the LBRB driving method.

Next, after the input of the data voltage Vd for the left eye input image signal L(W), the right eye input image signal R(B) is converted into the data voltage Vd for the right eye input image signal R(B) to be inputted into the pixel PX during one frame.

The light transmittance RES of the pixel PX that receives the data voltage Vd for the right eye input image signal R(B) gradually decreases. In accordance with the illustrated exemplary embodiment, since the light transmittance RES at the last viewing point of the previous frame is lower than the light transmittance RES' in the case that the clipping process is not performed, the light transmittance RES at the frame in which the data voltage Vd for the right eye input image signal R(B) is inputted may also be lower than the light transmittance RES' in the case that the clipping process is not performed as shown in FIG. 10, and may also be downwardly moved.

The light emitting blocks of the backlight 900 corresponding to the pixel PX that receives the data voltage Vd, or the backlight 900, may be turned on to emit light to the corresponding pixel during at least a part of the frame in which the data voltage Vd for the left eye input image signal L(W) is inputted and at least a part of the frame in which the data voltage Vd for the right eye input image signal R(B) is inputted as shown in FIG. 10. The on-timing and time of the backlight 900 may be variously changed without being limited to those shown therein.

Referring to FIG. 10, the luminance Lum(WB) of an image displayed by the pixel PX in the case that the clipped highest data voltage Vd_max for the left eye input image signal L(W) is applied may be lower than the luminance Lum′(WB) in the case that no clipping process is performed.

Next, when the light emitting blocks of the backlight 900 corresponding to the pixel PX, or the backlight 900, are turned on during at least a part of the frame in which the data voltage Vd for the right eye input image signal R(B) is inputted, the luminance Lum(BW) of an image displayed by the pixel PX may be lower than the luminance Lum′(BW) in the case that no clipping process is performed.

Accordingly, an effect of a left eye image for a right eye image indicating a black gray scale can be effectively removed, thereby displaying a luminance close to a target black gray scale. Particularly, when an image in which the pixel PX is changed from the white gray scale to the black gray scale is displayed, crosstalk between the left image and the right image may be reduced. Thus, according to the illustrated exemplary embodiment, it may be possible to increase display quality of the 3D image by reducing the crosstalk between the left image and the right image.

Particularly, in the case of the LR driving method, it may be possible to enable only an image displayed by the pixel PX of which transmittance reaches the target transmittance or reaches a transmittance value close to the target transmittance among the pixels PX of the display panel 300 by using the backlight 900 including light emitting blocks and turning on the light emitting blocks according to an application order of the data voltage. Accordingly, it may be possible to prevent the deterioration of a display quality caused by a slow response speed of the pixel PX and to further reduce the crosstalk of the left eye image and the right image of an adjacent frame.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A three dimensional (3D) image display device comprising:
a display panel comprising a plurality of pixels and a plurality of data lines;
a data driver configured to apply a data voltage to the data lines; and
a signal controller configured to receive an input image signal to generate an output image signal and control the data driver, the signal controller comprising a signal compensator to change the input image signal to have a clipped gray scale that is lower than a highest gray scale when the input image signal is the highest gray scale in a 3D mode.

2. The 3D image display device of claim 1, wherein the signal compensator changes the input image signal for a frame based on the input image signal and a previous image signal, which is an input image signal for a previous frame, to generate a changed input image signal, and
a highest gray scale of the changed input image signal is equal to the clipped gray scale.

3. The 3D image display device of claim 2, wherein the signal compensator comprises a lookup table for storing a value for the changed input image signal, the value for the changed input image signal being determined based on values of the input image signal and the previous image signal, and
the value for the changed input image signal corresponding to the highest gray scale of the input image signal is equal to the clipped gray scale.

4. The 3D image display device of claim 3, wherein the display panel displays an image of the input image signal during a plurality of frames in the 3D display mode.

5. The 3D image display device of claim 4, wherein the 3D display mode comprises an LHRH driving method in which the data voltage is not applied to the pixel during a holding period, the holding period being positioned between an input period of a left eye image signal of one frame and an input period of a right eye image signal of one frame.

6. The 3D image display device of claim 4, wherein the 3D display mode comprises an LLRR driving method in which a left or right eye image signal for the input image signal is input to the data driver multiple times in a plurality of continuous frames.

7. The 3D image display device of claim 4, further comprising
a backlight configured to emit light to the display panel,
wherein the backlight emits light to the pixel that displays the image of the input image signal during at least a part of the frames.

8. The 3D image display device of claim 3, wherein the 3D display mode comprises an LR driving method of alternatively inputting the left eye image signal for an input image signal and the right eye image signal for an input image signal to the data driver in a unit of a frame.

9. The 3D image display device of claim 8, further comprising
a backlight configured to emit light to the display panel,
wherein the backlight comprises a plurality of light emitting blocks corresponding to different regions of the display panel, the plurality of light emitting blocks respectively emitting light to the different regions of the display panel.

10. The 3D image display device of claim 9, wherein the light emitting blocks of the backlight are successively turned on according to an order in which the data voltage is applied to the pixels.

11. A driving method of a three dimensional (3D) image display device comprising a display panel comprising a plurality of pixels and a plurality of data lines, a data driver connected to the data lines, and a signal controller configured to control the data driver,
the method comprising:
receiving, by the signal controller, an input image signal;
generating, by the signal controller, an output image signal by changing the input image signal to have a clipped gray scale that is lower than a highest gray scale when the input image signal is the highest gray scale in a 3D display mode; and
inputting, by the signal controller, the output image signal to the data driver.

12. The driving method of claim 11, wherein the changing of the input image signal comprises: changing the input image signal based on the input image signal for a current frame and a previous image signal which is an input image signal for a previous frame to generate a changed input image signal,
wherein a highest gray scale of the changed input image signal is equal to the clipped gray scale.

13. The driving method of claim 12, wherein the signal controller comprises a lookup table for storing a value for the changed input image signal, the value for the changed input image signal being determined based on values of the input image signal and the previous image signal, and
the changed input image signal corresponding to the highest gray scale of the input image signal is equal to the clipped gray scale.

14. The driving method of claim 13, further comprising displaying an image of the input image signal during a plurality of frames, in the 3D mode.

15. The driving method of claim 14, wherein the 3D display mode comprises an LHRH driving method in which the data voltage is not applied to the pixel during a holding period, the holding period being positioned between an input period of a left eye image signal of one frame and an input period of a right eye image signal of one frame.

16. The driving method of claim 14, wherein the 3D display mode comprises an LLRR driving method in which a left or right eye image signal for the input image signal is input to the data driver multiple times in a plurality of continuous frames.

17. The driving method of claim 14, further comprising controlling a backlight configured to emit light to the display panel to emit light to the pixel that displays the image during at least a part of the frames.

18. The driving method of claim 13, wherein the 3D display mode comprises an LR driving method of alternatively inputting the left eye image signal for an input image signal and the right eye image signal for an input image signal to the data driver in a unit of a frame.

19. The driving method of claim 18, further comprising:
controlling a backlight configured to emit light to the display panel to respectively emit light to different regions of the display panel.

20. The driving method of claim 19, wherein the backlight comprises a plurality of light emitting blocks for respectively emitting light to corresponding regions of the display panel, and
the light emitting blocks of the backlight are successively turned on according to an order in which the data voltage is applied to the pixels.

21. A three dimensional (3D) image display device comprising:
a signal controller configured to receive an input image signal to generate an output image signal, the output image signal comprising a left eye image signal in a first frame and a right eye image signal in a second frame, the first frame and the second frame being comprised in frames of a 3D mode;
a data driver configured to apply a data voltage to a data line;
a display panel comprising a plurality of pixels, the display panel being coupled to the data line; and
a signal compensator to change the input image signal to have a clipped gray scale that is lower than a highest gray scale in the 3D mode.

22. The 3D image display device of claim 21, wherein the signal compensator changes the input image signal based on a value of the input image signal and a value of a previous input image signal.

23. The 3D image display device of claim 21, further comprising:
a backlight configured to be turned off during a first portion of the first frame and turned on during a second portion of the first frame.

24. The 3D image display device of claim 21, further comprising:
a backlight configured to be turned off during the first frame and turned on during a portion of a hold frame in which the data voltage is not applied to the data line.
